(19) United States
(12) Patent Application Publication
(10) Pub. No.: US 2026/0284562 A1
(43) Pub. Date: Sep. 24, 2026

(54) LYE OUTLET WITHIN A LYE FILTER

(71) Applicant: JOHN COCKERILL HYDROGEN BELGIUM, Seraing (BE)

(72) Inventor: Clement Izzi, Seraing (BE)

(73) Assignee: JOHN COCKERILL HYDROGEN BELGIUM, Seraing (BE)

(21) Appl. No.: 19/475,881

(22) PCT Filed: Apr. 19, 2024
(86) PCT No.: PCT/EP2024/060838

§ 371 Date: Oct. 16, 2025

(30) Foreign Application Priority Data
Apr. 21, 2023 (BE) 2023/5312
Jul. 28, 2023 (BE) 2023/5631

(51) Int. Cl. B01D 35/30; B01D 29/35; B01D 35/027; C25B 15/08

(52) U.S. Cl. CPC B01D 35/30; B01D 29/35; B01D 35/0276; C25B 15/085

(57) ABSTRACT

A lye filtering unit (10) capable of filtering ferrous residues and iron precipitates as well as any other substance present in an electrolyte solution coming from an electrolysis unit is provided. The lye filtering unit (10) includes a tank (12) extending in a main direction of vertical elongation (A) and a side wall (18); an inlet pipe for lye to enter the tank (12); and an outlet pipe (46) for lye to exit the tank (12), the lye filtering unit (10) being characterised in that the lye outlet pipe (46) has a portion of decreasing cross-section (48) in the lye discharge direction.

### TECHNICAL FIELD OF THE INVENTION

The present invention relates to a lye filtration unit capable of filtering ferrous residues and iron precipitates, and also any other impurity, present in an electrolyte solution coming from an electrolysis unit, for example for the production of dihydrogen (H2) and dioxygen (O2).

The invention relates more particularly to a lye filtration unit designed to be easier to maintain.

### TECHNICAL BACKGROUND

A lye filter, also known as a lye filtration unit, is used to filter ferrous residues, iron precipitates, and also any other impurity present, even in negligible quantities.

FIGS. 1 and 2 show a lye filtration unit 100 according to the prior art. The lye filtration unit 100 comprises a tank 12 having a lye inlet pipe 44 and a lye outlet pipe 46 as well as two impurity capturing elements arranged in the tank 12, namely:
i) at least one bar magnet 28 for collecting the magnetic particles (regardless of dimension), and
ii) a basket 30 supporting an inner screen formed of a tight metal mesh intended to capture non-magnetic particles (regardless of size).

Following this action of capturing molecules, the lye filter 100 has to be cleaned of these agglomerates of iron and/or of any other substance on a regular basis in order to maintain the effectiveness of the system. All of the agglomerates of iron, minor substances and molecules filtered are considered to be impurities.

This maintenance operation is fairly laborious and not very straightforward, given the mass and the steric hindrance of the lye filter 100 as well as those associated with the bar magnet(s) 28 and the basket 30 within the lye filter 100.

The elements that make the maintenance operation difficult are the following:
i) the basket 30 containing a screen formed of an extremely heavy tight metal mesh, which is attached using screws to a shim on the side wall of the lye filter 100 and which is characterized in that the bottom is located in the vicinity of the lower end of the lye filter 100, and
ii) the bar magnet(s) 28, which is/are attached directly to the cover of the lye filter 100, the cover being surmounted by at least one handle required for lifting the assembly made up of the cover and the bar magnet(s) 28.

Conventionally, the lye inlet pipe 44 and the lye outlet pipe 46 are similar in shape and size. As shown in FIGS. 1 and 2 from the prior art, the lye inlet pipe 44 and the lye outlet pipe 46 are cylindrical and of constant circular section. The section of the lye inlet pipe 44 and the section of the lye outlet pipe 46 have identical dimensions. The friction and the resistance to the circulation of lye caused by the elements inside the tank 12 result in a head loss between the lye inlet pipe 44 and the lye outlet pipe 46. Thus, the pressure in the lye outlet pipe 46 is lower than the pressure in the lye inlet pipe 44, this being a completely coherent physical phenomenon.

In addition thereto, the join between the lye inlet pipe 44 or lye outlet pipe 46 and the tank 12 leaks in exceptional cases insofar as the join is not always entirely leaktight following a failure identified at the weld between the lye inlet pipe 44 or lye outlet pipe 46 and the tank 12. Leaks accentuate the head losses between the lye inlet pipe 44 and the lye outlet pipe 46.

The head losses between the lye inlet pipe 44 and the lye outlet pipe 46 are detrimental to the correct operation of the lye filtration unit 100. In particular, they result in impurities accumulating in the vicinity of the lye outlet pipe 46, thereby clogging the basket 30 locally and hindering filtration. The basket 30 being clogged in the vicinity of the outlet requires a maintenance operation to be carried out on the lye filtration unit 100 in order to clean the basket 30.

### SUMMARY OF THE INVENTION

The invention relates to a lye filtration unit capable of filtering ferrous residues and iron precipitates, and also any other impurity, present in an electrolyte solution coming from an electrolysis unit, the lye filtration unit comprising:
a tank extending in a main direction of vertical elongation, a main direction horizontal elongation, or any main direction elongation between the horizontal and vertical planes defined according to the reference system V, L, T, and comprising a side wall,
   an inlet pipe for letting lye into the tank, and
   an outlet pipe for letting lye out of the tank,
the lye outlet pipe having a portion of decreasing section along the lye discharge direction.

The lye inlet pipe may be fluidically connected to an inlet orifice in the side wall.

The outlet pipe may be fluidically connected to an outlet orifice in the side wall.

The outlet pipe may be located below the inlet pipe.

The outlet pipe may have the shape of a funnel, so that, by virtue of the widening of the outlet pipe in contact with the tank, the lye can be extracted at a significant rate without entraining any impurity since the latter has been removed from the tank beforehand.

The portion of decreasing section may have a circular section.

The diameter of the portion of decreasing section may decrease linearly.

The length of the portion of decreasing section along the lye discharge direction may be equal to the minimum diameter of the portion of decreasing section multiplied by a coefficient.

The maximum diameter of the portion of decreasing section may be equal to the minimum diameter of the portion of decreasing section multiplied by a coefficient.

The minimum diameter of the portion of decreasing section may be equal to the diameter of the section of the inlet pipe.

### BRIEF DESCRIPTION OF THE FIGURES

Further features and advantages of the invention will become apparent from reading the following detailed description, for the understanding of which reference will be made to the appended drawings, in which:

FIG. 1 is a perspective view of a lye filtration unit from the prior art;

FIG. 2 is a schematic cross-sectional view of the lye filtration unit in FIG. 1 that shows the arrangement of the bar magnet and the basket in the lye filtration unit;

FIG. 3 is a perspective view of a lye filtration unit according to the invention showing the outlet pipe having a portion of decreasing section;

FIG. 4 is a cross-sectional view of the lye filtration unit in FIG. 3 showing the respective shapes of the inlet and outlet pipes,

FIG. 5 is a partial schematic view of the interior of the tank showing an endpiece of the bar magnet of the lye filtration unit in FIG. 3.

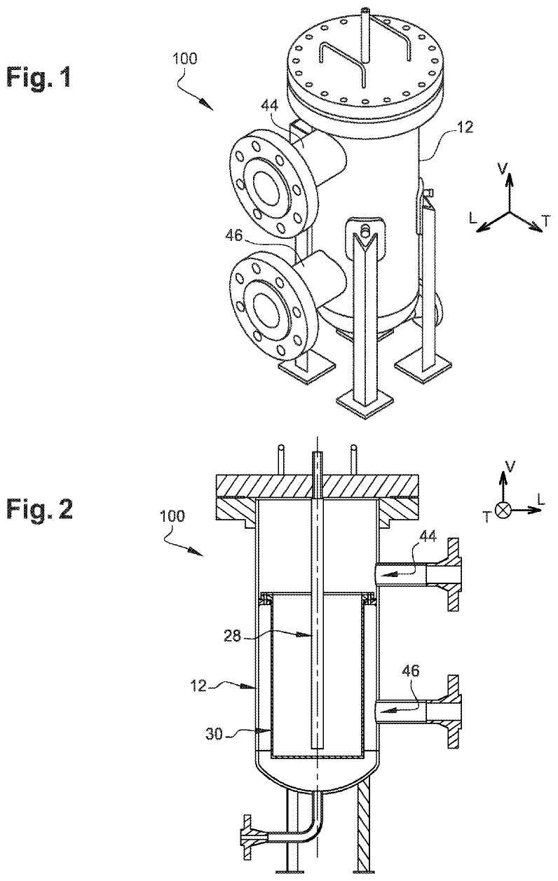

### DETAILED DESCRIPTION OF THE INVENTION

For the description of the invention and the understanding of the claims, the vertical, longitudinal and transverse orientations will be adopted non-limitingly, and without limiting reference to the gravitational field of the Earth, according to the reference system V, L, T indicated in the figures, in which the longitudinal axis L and transverse axis T extend in a horizontal plane. By convention, the vertical axis V is oriented from the bottom upward and the longitudinal axis L is oriented from the rear forward.

In the following description, elements that are identical, similar or analogous will be denoted by the same reference numerals.

The invention relates to a lye filtration unit 10 capable of filtering ferrous residues and iron precipitates, and also any other impurity, in an electrolyte solution coming from an electrolysis unit.

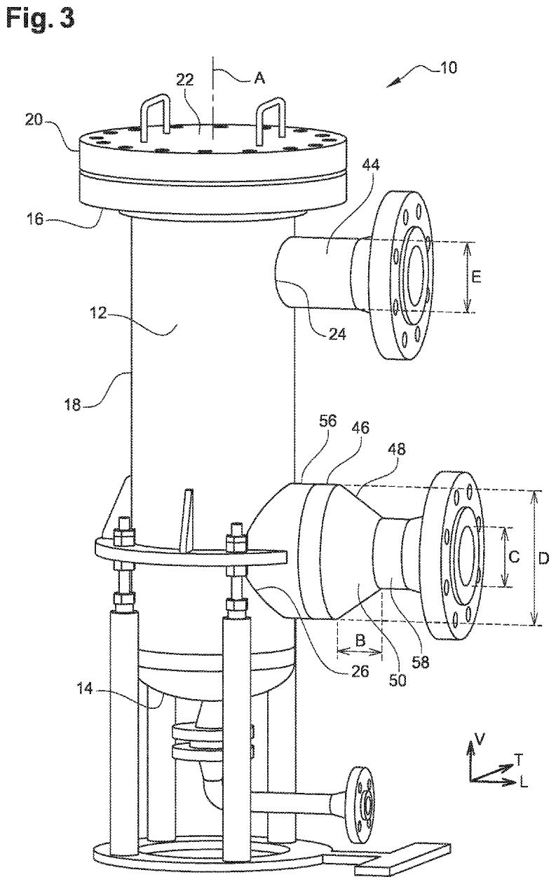

A lye filtration unit 10 according to the invention is shown in FIG. 3. The lye filtration unit 10 comprises a tank 12 extending in a main direction of vertical elongation A between a lower face 14 and an upper face 16.

The tank 12 comprises a side wall 18. The tank 12 has a cylindrical overall shape of axis A and circular section. The side wall 18 is curved and extends along the circumference of the cylinder formed by the tank 12. The side wall 18 is parallel to the axis A. Any other geometric configuration defining the side wall 18 falls within the description of the present invention, given that the technical features associated therewith are independent of the geometric configuration.

In order to allow access to the interior of the tank 12, for example for an operator to carry out an intervention, the upper face 16 comprises an opening 20. The lye filtration unit 10 comprises a cover 22 capable of cooperating with the upper face 16 of the tank 12 to close the opening 20 and to make it possible to hermetically seal the tank 12.

The tank 12 comprises a lye inlet orifice 24 and a lye outlet orifice 26. Thus, the lye coming from the electrolysis unit is introduced into the tank 12 of the lye filtration unit 10 via the lye inlet orifice 24. The lye introduced into the tank 12 via the lye inlet orifice 24 passes through the tank 12 in order to be filtered and exits again via the lye outlet orifice 26. Once filtered, the lye can be reinjected into the electrolysis unit. The lye inlet orifice 24 and the lye outlet orifice 26 are arranged in the side wall 18. The lye inlet orifice 24 and lye outlet orifice 26 may be positioned, for example, one above the other. The lye inlet orifice 24 and lye outlet orifice 26 may also be positioned in diametrically opposed positions or may have any orientation. Preferably, the lye inlet orifice 24 is located in an upper portion of the side wall 18 and the lye outlet orifice 26 is located in a lower portion of the side wall 18 to allow the stream of lye to flow under gravity.

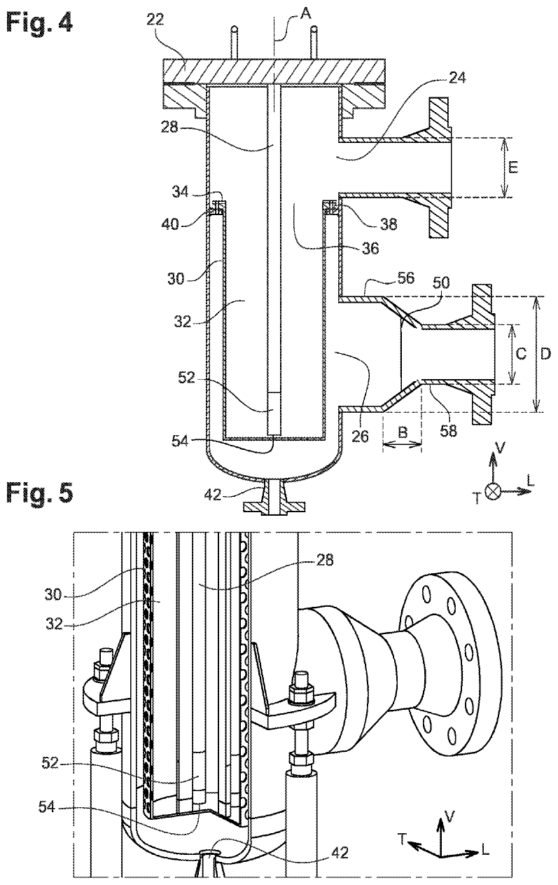

With reference to FIGS. 4 and 5, the lye filtration unit 10 comprises at least one bar magnet 28 extending vertically between the inlet orifice 24 and the outlet orifice 26. The bar magnet 28 is advantageously attached to a lower face of the cover 22 and extends downward when the cover 22 is positioned so as to close the opening 20.

With this arrangement, the lye circulating from the inlet orifice 24 to the outlet orifice 26 contacts the bar magnet 28, the magnetic field of which makes it possible to capture magnetic particles. As will be understood, the bar magnet 28 extracts magnetic particles that may be immersed in the lye rushing into the tank 12 via the inlet orifice 24, before it is reinjected into the circuit of the electrolysis unit through the outlet orifice 26.

The lye filtration unit 10 comprises a basket 30 delimiting a cavity 32 extending in the vertical direction A. The basket 30 has a cylindrical shape of axis A. The basket 30 comprises an upper face 34 delimiting a central opening 36 capable of receiving the bar magnet 28. The upper face 34 of the basket 30 also comprises a peripheral rim 38 capable of resting on a shim 40 projecting from an inner face of the side wall 18. The upper face 34 of the basket 30 is in this case arranged halfway up the tank 12 between the lye inlet orifice 24 and the lye outlet orifice 26. Thus, the lye entering the tank 12 rushes into the cavity 32, passes through the walls of the basket 30 and exits via the lye outlet orifice 26.

The lye filtration unit 10 comprises a purge orifice 42 arranged in the lower face 14 of the tank 12.

In order to enable the lye to circulate, the lye filtration unit 10 comprises:
an inlet pipe 44 for letting lye into the tank 12, and
an outlet pipe 46 for letting lye out of the tank 12.

The lye inlet pipe 44 is fluidically connected to the lye inlet orifice 24 in the side wall 18.

The lye outlet pipe 46 is fluidically connected to the lye outlet orifice 26 in the side wall 18.

The lye can circulate within a closed circuit between the electrolysis unit and the lye filtration unit 10. The lye conveyed in the lye inlet pipe 44 comes from the electrolysis unit. The lye discharged in the lye outlet pipe 46 is redirected toward the electrolysis unit, potentially following an additional treatment.

According to one feature of the invention, the lye outlet pipe 46 has a portion of decreasing section 48 along the lye discharge direction, which corresponds in this case to the direction indicated by the longitudinal vector L, this decreasing section 48 being preceded by a proximal portion 56, arranged between the tank 12 and the portion of decreasing section 48, of a larger size than the decreasing section 48 as well as the lye inlet section 44. The outlet pipe 46 further comprises a distal portion 58, which extends the portion of decreasing section 48 downstream.

This particular shaping feature of the outlet pipe 46 is recommended in order to provide a dual benefit.

On the one hand, by adopting such a progressive reduction in section of the outlet pipe 46 into which the lye rushes as it passes through the outlet orifice 26, the decreasing section 48 forms a converging portion that limits the generation of singular head losses in comparison with a sudden reduction in section, specifically if the lye were led directly into the distal portion 58 at the outlet of the tank 12. This limitation of head losses makes it possible to avoid impurities accumulating on a portion of the basket 30 in the vicinity of the lye outlet pipe 46.

According to one exemplary embodiment, the lye outlet pipe 46 is located below the lye inlet pipe 44. The lye outlet pipe 46 is lower than the inlet pipe 44 in order to promote the flow of lye from the inlet to the outlet. Furthermore, the lye inlet pipe 44 is located vertically in line with the lye outlet pipe 46. This is conventionally imposed by the arrangement of the circuit connecting the lye filtration unit 10 to the electrolysis unit. As a variant, the lye inlet pipe 44 and lye outlet pipe 46 may be diametrically opposed or may have any orientation.

The lye outlet pipe 46 has the shape of a horizontal funnel, the axis of the funnel extending in the longitudinal direction L. The portion of decreasing section 48 has a circular section 50.

The diameter of the portion of decreasing section 48 decreases linearly along the direction L between a maximum diameter D and a minimum diameter C.

The lye outlet pipe 46 comprises a proximal portion 56 arranged between the tank 12 and the portion of decreasing section 48, the proximal portion 56 being cylindrical in shape and of diameter equal to the maximum diameter D.

The distal portion 58 of the outlet pipe 46, arranged downstream of the portion of decreasing section 48, is cylindrical in shape and has a diameter equal to the minimum diameter C.

The length B of the portion of decreasing section 48 along the lye discharge direction L is equal to the minimum diameter C of the portion of decreasing section 48 multiplied by a coefficient.

The maximum diameter D of the portion of decreasing section 48 is equal to the minimum diameter C of the portion of decreasing section 48 multiplied by a coefficient.

The minimum diameter C of the portion of decreasing section 48 is equal to the diameter E of the section of the lye inlet pipe 44.

As described above, the inlet and outlet pipes are advantageously dimensioned so that the diameter E of the inlet pipe 44, through which the lye enters the tank 12, is smaller than the diameter D of the proximal portion 56 through which the lye is purged from the tank 12. As a direct consequence of the principle of conservation of the flow rate between the inlet and the outlet of the tank 12, this particular dimensioning of the proximal portion 56 of smaller diameter than the inlet pipe 44 results in a reduction in the fluid propagation speed at the outlet of the tank with respect to the case in which these diameters are equal. Since the lye flows at a lower speed at the outlet of the tank 12, it is thus easier to retain the particles in the tank 12.

As will be understood, this particular dimensioning exacerbates the effect of overpressure upstream of the outlet pipe caused by the converging portion formed by the decreasing section 48 on the retention of the particles in the tank 12, while allowing a favorable flow of lye at the outlet of the tank 12.

It should be noted that this shaping of the proximal portion 56 with a larger diameter D, at the outlet orifice 26, than the diameter E of the section of the inlet pipe 44, at the inlet orifice 24, does not in any way require any geometric and configurational modification of the tank 12 and, as a result, of the overall architecture of the lye filtration unit 10.

The bar magnet 28 comprises an endpiece 52 fitted onto the bottom end of the bar magnet 28. The endpiece 52 has the shape of a hollow cylinder and also has a solid lower face 54 in contact with the basket 30 making it possible to maintain the basket 30 at a given depth and to prevent it retracting under the effect of the pressure differentials.

The above-described preferential embodiments nevertheless make it possible to consider any orientation of the lye filtration unit 10. Thus, the latter may be arranged in a main direction of horizontal elongation or any main direction of elongation between the horizontal and vertical planes defined according to the reference system V, L, T. Regardless of the orientation followed, all the technical features associated with the geometric configurations of the lye filtration unit 10 and constituent elements of the invention (lye inlet orifice 24, lye outlet orifice 26, bar magnets 28, basket 30, etc.) described in the description remain identical, giving a set of identical results.

1. A lye filtration unit (10) capable of filtering ferrous residues and iron precipitates, and also any other impurity, in an electrolyte solution coming from an electrolysis unit, the lye filtration unit (10) comprising:
a tank (12) extending in a main direction of vertical elongation (A), a main direction of horizontal elongation, or any main direction of elongation between the horizontal and vertical planes defined according to a reference system V, L, T, and comprising a side wall (18),
an inlet pipe for letting lye into the tank (12), the lye inlet pipe (44) being fluidically connected to a lye inlet orifice (24) in the side wall (18),
an outlet pipe (46) for letting lye out of the tank (12), the lye outlet pipe (46) being fluidically connected to a lye outlet orifice (26) in the side wall (18),
a basket (30) delimiting a cavity (32) extending in the main direction of elongation (A), the basket (30) comprising an upper face (34) that is arranged between the lye inlet orifice (24) and the lye outlet orifice (26), and
the lye filtration unit (10) being characterized in that the lye outlet pipe (46) has a portion of decreasing section (48) along the lye discharge direction.

2. (canceled)

3. (canceled)

4. The lye filtration unit (10) as claimed in claim 1, wherein:
the outlet pipe (46) comprises a proximal portion (56) through which the lye passes before the portion of decreasing section (48) as it passes through the outlet orifice (26);
the diameter (D) of the proximal portion (56) of the outlet pipe (46) is greater than the diameter (E) of the inlet pipe

5. The lye filtration unit (10) as claimed in claim 1, characterized in that the lye outlet pipe (46) is located below the lye inlet pipe (44).

6. The lye filtration unit (10) as claimed in claim 1, characterized in that the lye outlet pipe (46) has the shape of a funnel.

7. The lye filtration unit (10) as claimed in claim 1, characterized in that the portion of decreasing section has a circular section (50).

8. The lye filtration unit (10) as claimed in claim 1, characterized in that the diameter of the portion of decreasing section (48) decreases linearly.

9. The lye filtration unit (10) as claimed in claim 7, characterized in that the minimum diameter (C) of the portion of decreasing section (48) is equal to the diameter (E) of the section of the lye inlet pipe

10. The lye filtration unit (10) as claimed in claim 4, characterized in that the lye outlet pipe (46) is located below the lye inlet pipe (44).

11. The lye filtration unit (10) as claimed in claim 4, characterized in that the lye outlet pipe (46) has the shape of a funnel.

12. The lye filtration unit (10) as claimed in claim 5, characterized in that the lye outlet pipe (46) has the shape of a funnel.

13. The lye filtration unit (10) as claimed in claim 4, characterized in that the portion of decreasing section (48) has a circular section (50).

14. The lye filtration unit (10) as claimed in claim 5, characterized in that the portion of decreasing section (48) has a circular section (50).

15. The lye filtration unit (10) as claimed in claim 6, characterized in that the portion of decreasing section (48) has a circular section (50).

16. The lye filtration unit (10) as claimed in claim 1, characterized in that the diameter of the portion of decreasing section (48) decreases linearly.

17. The lye filtration unit (10) as claimed in claim 4, characterized in that the diameter of the portion of decreasing section (48) decreases linearly.

18. The lye filtration unit (10) as claimed in claim 5, characterized in that the diameter of the portion of decreasing section (48) decreases linearly.

19. The lye filtration unit (10) as claimed in claim 6, characterized in that the diameter of the portion of decreasing section (48) decreases linearly.

20. The lye filtration unit (10) as claimed in claim 7, characterized in that the diameter of the portion of decreasing section (48) decreases linearly.

21. The lye filtration unit (10) as claimed in claim 8, characterized in that the diameter of the portion of decreasing section (48) decreases linearly.
